(19) United States
(12) Patent Application Publication
(10) Pub. No.: US 2025/0179930 A1
(43) Pub. Date: Jun. 5, 2025

(54) STEAM VALVE AND STEAM TURBINE PLANT INCLUDING THIS

(71) Applicants: KABUSHIKI KAISHA TOSHIBA, Tokyo (JP); TOSHIBA ENERGY SYSTEMS & SOLUTIONS CORPORATION, Kawasaki-shi (JP)

(72) Inventors: Kazuhiro YOKOSHIMA, Yokohama Kanagawa (JP); Yasutaka KAWADA, Kawasaki Kanagawa (JP); Kouhei YAMADA, Kawasaki Kanagawa (JP); Shunichi HORII, Yokohama Kanagawa (JP); Shogo YOSHIHARA, Yokohama Kanagawa (JP); Ryuhei TAKEMARU, Yokohama Kanagawa (JP)

(73) Assignees: KABUSHIKI KAISHA TOSHIBA, Tokyo (JP); TOSHIBA ENERGY SYSTEMS & SOLUTIONS CORPORATION, Kawasaki-shi (JP)

(21) Appl. No.: 18/770,241

(22) Filed: Jul. 11, 2024

(30) Foreign Application Priority Data
Nov. 30, 2023 (JP) 2023-202328

(51) Int. Cl. F01D 17/14; F16K 1/12; F16K 1/36; F16K 25/00

(52) U.S. Cl. CPC F01D 17/145; F16K 1/36; F16K 1/126; F16K 25/005

(57) ABSTRACT

A steam valve of an embodiment includes: a valve casing including a steam inlet portion, a steam outlet portion, and a steam chamber, and having an opening portion communicating with the steam chamber; a valve seat provided in the steam chamber in the valve casing; a valve cover installed on the valve casing to close the opening portion, and having a through hole; a bush in a cylindrical shape, fitted in the through hole; a valve rod penetrating the bush to be slidable therein; and a valve element provided at one end of the valve rod. On an outer peripheral surface of the valve rod sliding in the bush, or an inner peripheral surface of the bush, a coating layer by PVD is formed.

### CROSS REFERENCE TO RELATED APPLICATIONS

This application is based upon and claims the benefit of priority from Japanese Patent Application No. 2023-202328, filed on Nov. 30, 2023; the entire contents of which are incorporated herein by reference.

### FIELD

Embodiments described herein relate generally a steam valve and a steam turbine plant including this.

### BACKGROUND

A steam valve included in a steam turbine plant has a function of controlling a shutoff and a steam amount of inflow steam to a steam turbine. FIG. 9 is a view illustrating a vertical section of a conventional steam control valve in use for a steam turbine plant.

In a steam control valve 200 illustrated in FIG. 9, a valve casing 218 is closed by a valve cover 213. A valve rod 210 is provided to penetrate the valve cover 213. At one end of the valve rod 210, a valve element 211 is provided, and the other end of the valve rod 210 is coupled to a hydraulic drive mechanism 215 supported by the valve cover 213. In a penetration portion of the valve cover 213, a bush 214 penetrated by the valve rod 210 is provided. An inner peripheral surface 214a of the bush 214 and an outer peripheral surface 210a of the valve rod 210 constitute a sliding surface.

The valve rod 210 is driven in an up-down direction by the hydraulic drive mechanism 215, and thereby the valve element 211 abuts on or separates open from the valve seat 212. Thus, a flow rate of steam flowing in from a steam inlet portion 216 and flowing out from a steam outlet portion 217 is regulated.

In the steam control valve 200, a gap between the valve rod 210 and the bush 214 cannot be made zero because it allows the valve rod 210 to move in the up-down direction. Thus, the outer peripheral surface 210a of the valve rod 210 and the inner peripheral surface 214a of the bush 214 have a predetermined gap therebetween.

In the steam turbine driven by high-temperature steam, oxide scale is known to be gradually deposited on the outer peripheral surface 210a of the valve rod 210 and the inner peripheral surface 214a of the bush 214 as time elapses. When the gap between the valve rod 210 and the bush 214 is closed by the deposition of oxide scale, galling (stick) of the valve rod 210 occurs.

When the galling of the valve rod 210 occurs during operation of the steam turbine, a control function of a flow rate of steam flowing into the steam turbine and a steam shutoff function in an emergency are impaired. Thus, for preventing the galling of the valve rod 210, it is essential to perform regular disassembly and inspection of the steam valve, and remove the oxide scale deposited on the outer peripheral surface 210a of the valve rod 210 and the inner peripheral surface 214a of the bush 214.

In general, a deposition amount of oxide scale increases in proportion to an operating time of the steam turbine. Thus, the larger the gap between the valve rod 210 and the bush 214 is, the longer a time that elapsed before the galling of the valve rod 210 occurs becomes.

However, when the gap between the valve rod 210 and the bush 214 is increased, problems arise such as progress of abrasion and an increase in vibration of a sliding portion due to a swing in a radial direction of the valve rod 210, a hitting defect of the valve element 211 and the valve seat 212 due to a deviation from the center of the valve rod 210, and a decrease in thermal efficiency as the steam turbine plant due to steam leakage from the gap between the valve rod 210 and the bush 214.

Consequently, the gap between the valve rod 210 and the bush 214 is required to be properly set within a range where the above-described problems do not arise, and to be subjected to a regular removal of oxide scale to prevent the occurrence of galling of the valve rod 210.

On the other hand, in recent years, needs for a longer interval of an inspection cycle in the steam turbine are increasing. However, as described previously, in the steam valve, oxide scale is required to be regularly removed. Thus, for achieving the longer interval of the inspection cycle, reducing a rate at which oxide scale is deposited is crucial.

Here, a part of leakage steam is condensed by cooling of the leakage steam, or the like, and thereby oxide scale is gradually deposited with time in the gap between the valve rod 210 and the bush 214. Therefore, in a conventional steam valve, a study for further reducing the leakage steam from the gap between the valve rod 210 and the bush 214 is made.

However, in the conventional steam valve, further reducing the leakage steam makes a structure of the steam valve complicated. That is, in the conventional steam valve, it has been difficult to reduce an amount of the leakage steam from the gap between the valve rod and the bush with a simple structure, and reduce a deposition amount of oxide scale.

### BRIEF DESCRIPTION OF THE DRAWINGS

FIG. 1 is a diagram illustrating a system configuration of a steam turbine plant including a steam valve of a first embodiment.

FIG. 2 is a view illustrating a vertical section of the steam valve of the first embodiment.

FIG. 3 is a view enlarging and illustrating a cross section of a part of the steam valve of the first embodiment.

FIG. 4 is a view illustrating a vertical section of a steam valve of a second embodiment.

FIG. 5 is a view enlarging and illustrating a cross section of a part of the steam valve of the second embodiment.

FIG. 6 is a view illustrating a vertical section of a steam valve of a third embodiment.

FIG. 7 is a view enlarging and illustrating a cross section of a part of the steam valve of the third embodiment.

FIG. 8 is a view enlarging and illustrating a cross section of a part of a steam valve of a fourth embodiment.

FIG. 9 is a view illustrating a vertical section of a conventional steam control valve used in a steam turbine plant.

### DETAILED DESCRIPTION

Hereinafter, embodiments of the present invention will be described in reference to the drawings.

In one embodiment, a steam valve includes: a valve casing including a steam inlet portion, a steam outlet portion, and a steam chamber, and having an opening portion communicating with the steam chamber; a valve seat provided in a vicinity of the steam outlet portion in the steam chamber in the valve casing; a valve cover installed on the valve casing to close the opening portion, and having a through hole; a bush in a cylindrical shape, fitted in the through hole; a valve rod penetrating the bush to be slidable therein; and a valve element provided at one end of the valve rod, and provided to be capable of abutting on the valve seat. Further, a PVD coating layer is formed on an outer peripheral surface of the valve rod sliding in the bush, or an inner peripheral surface of the bush.

### First Embodiment

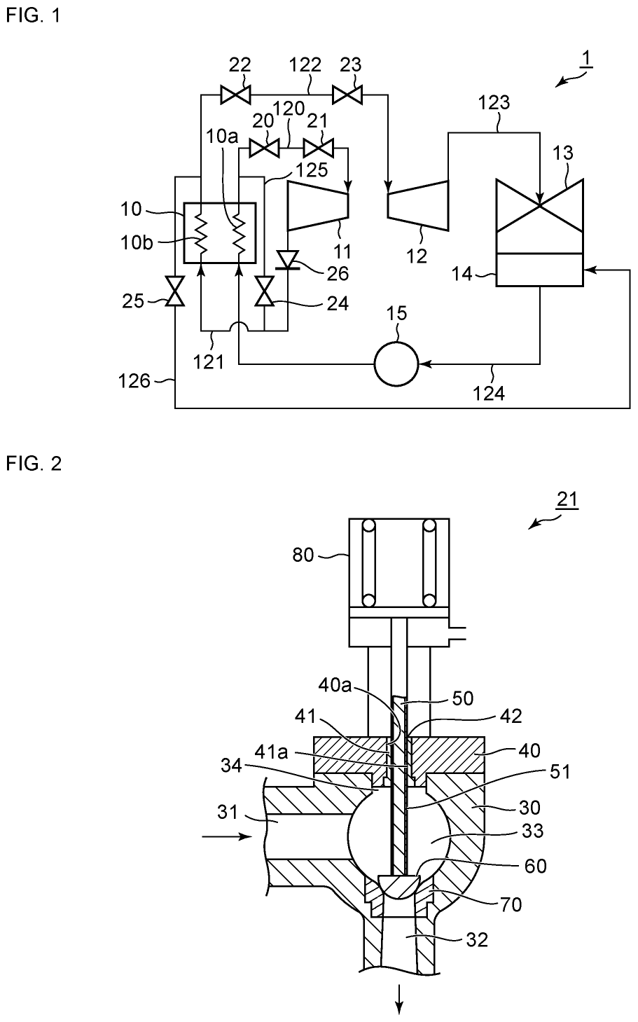

FIG. 1 is a diagram illustrating a system configuration of a steam turbine plant 1 including a steam valve of a first embodiment. As illustrated in FIG. 1, the steam turbine plant 1 includes a boiler 10, a high-pressure turbine 11, an intermediate-pressure turbine 12, a low-pressure turbine 13, a condenser 14, and a feed pump 15. Further, the steam turbine plant 1 includes a main steam stop valve 20, a steam control valve 21, a reheat steam stop valve 22, an intercept valve 23, a high-pressure turbine bypass valve 24, a low-pressure turbine bypass valve 25, and a check valve 26.

Here, as the steam valve of this embodiment, for example, there can be cited the above-described main steam stop valve 20, steam control valve 21, reheat steam stop valve 22, intercept valve 23, high-pressure turbine bypass valve 24, low-pressure turbine bypass valve 25, check valve 26, and so on. That is, a configuration of this embodiment can be applied to these valves.

In the boiler 10, a superheater 10a and a reheater 10b are provided. Note that the boiler 10 functions as a steam generator. High-pressure steam (main steam) generated in the superheater 10a passes through the main steam stop valve 20 and the steam control valve 21 interposed in a main steam pipe 120 to be supplied to the high-pressure turbine 11. The main steam supplied to the high-pressure turbine 11 flows while expanding in the high-pressure turbine 11 to drive the high-pressure turbine 11.

The steam exhausted from the high-pressure turbine 11 (low-temperature reheat steam) is guided to the reheater 10b of the boiler 10 via the check valve 26 interposed in a low-temperature reheat steam pipe 121 to be heated (reheated), and becomes reheat steam. The reheat steam from the reheater 10b is supplied to the intermediate-pressure turbine 12 via the reheat steam stop valve 22 and the intercept valve 23 interposed in a high-temperature reheat steam pipe 122. The reheat steam supplied to the intermediate-pressure turbine 12 flows while expanding in the intermediate-pressure turbine 12 to drive the intermediate-pressure turbine 12. The steam discharged from the intermediate-pressure turbine 12 flows into the low-pressure turbine 13 through a crossover pipe 123 to drive the low-pressure turbine 13.

The steam discharged from the low-pressure turbine 13 is guided to the condenser 14. The steam guided to the condenser 14 is cooled and condensed in the condenser 14 to be returned to water (condensed water). The water (condensed water) condensed in the condenser 14 is pressurized by the feed pump 15 interposed in a feed pipe 124, and guided to the superheater 10a of the boiler 10. In the steam turbine plant 1, a steam-water circulating system (heat cycle) is formed as described above.

Further, depending on the steam turbine plant 1, to enhance operation efficiency, a high-pressure turbine bypass pipe 125 connecting an inflow side of the main steam stop valve 20 and an inflow side of the reheater 10b is provided. In the high-pressure turbine bypass pipe 125, the high-pressure turbine bypass valve 24 is provided. In this configuration, opening the high-pressure turbine bypass valve 24 allows the operation in a manner in which the main steam from the superheater 10a bypasses the high-pressure turbine 11.

Further, depending on the steam turbine plant 1, a low-pressure turbine bypass pipe 126 connected between an outflow side of the reheater 10b and the condenser 14 is provided. In the low-pressure turbine bypass pipe 126, the low-pressure turbine bypass valve 25 is provided. In this configuration, opening the low-pressure turbine bypass valve 25 allows the operation in a manner in which the reheat steam from reheater 10b bypasses the intermediate-pressure turbine 12 and the low-pressure turbine 13.

Providing the high-pressure turbine bypass pipe 125 and the low-pressure turbine bypass pipe 126 as described above allows circulation operation of the steam turbine plant with a boiler system alone without depending on operation of the steam turbines.

Next, a configuration of the steam valve of the first embodiment will be described.

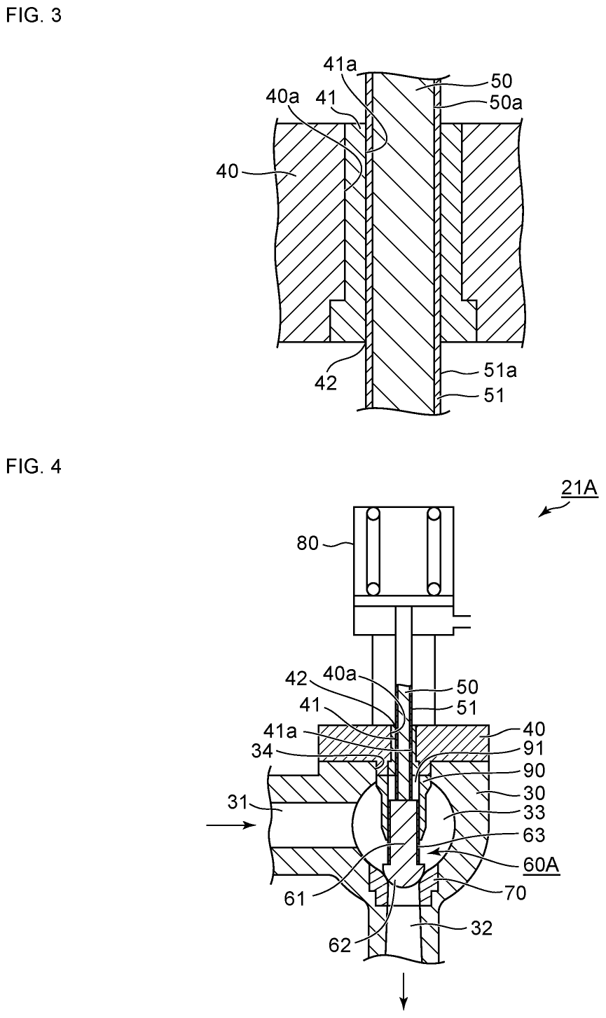

FIG. 2 is a view illustrating a vertical section of the steam valve of the first embodiment. FIG. 3 is a view enlarging and illustrating a cross section of a part of the steam valve of the first embodiment. Here, the steam control valve 21 is exemplified to be described as the steam valve of the first embodiment.

As illustrated in FIG. 2, the steam control valve 21 includes a valve casing 30, a valve cover 40, a valve rod 50, a valve element 60, and a valve seat 70.

The valve casing 30 has a steam inlet portion 31 which introduces the main steam from the boiler 10, and a steam outlet portion 32 which makes the steam flow out. Here, an example in which the steam outlet portion 32 is configured to guide the main steam flowing in from a horizontal direction via the steam inlet portion 31 to a vertically lower side is presented.

An upper surface of the valve casing 30 facing the steam outlet portion 32 has an opening portion 34 communicating with a steam chamber 33. The opening portion 34 is closed by the valve cover 40, and the steam chamber 33 is formed in the interior of the valve casing 30. The valve seat 70 is provided in a connection portion with the steam outlet portion 32 in the interior of the valve casing 30. Here, the steam chamber 33 is a space on a downstream side of the steam inlet portion 31 and on an upstream side further than an abutting portion of the valve seat 70 abutting on the valve element 60 in a space formed in the interior of the valve casing 30.

A through hole 40a is formed through a center portion of the valve cover 40. A bush 41 is fitted in the through hole 40a. The bush 41 is constituted by a cylindrical member having a through hole 42 in a longitudinal direction at the center thereof. Note that the bush 41 is fitted in the through hole 40a of the valve cover 40 by expansion fit or the like.

The valve rod 50 is provided to penetrate the through hole 42 of the bush 41. At one end of the valve rod 50, the valve element 60 is provided, and the other end of the valve rod 50 is coupled to a hydraulic drive mechanism 80 supported by the valve cover 40. Note that a center axis of the bush 41 is located coaxially with a center axis of the valve rod 50.

As illustrated in FIG. 3, on an outer peripheral surface 50a of the valve rod 50, a coating layer 51 is formed. An outer peripheral surface 51a of the coating layer 51 and an inner peripheral surface 41a of the bush 41 constitute a sliding surface. On the outer peripheral surface 50a of the valve rod 50, the coating layer 51 is formed on at least a portion of sliding with the inner peripheral surface 41a of the bush 41.

Here, an example in which the coating layer 51 is formed on the outer peripheral surface 50a of the valve rod 50 is presented. The coating layer 51 may be formed on the inner peripheral surface 41a of the bush 41. That is, the coating layer 51 is formed on the outer peripheral surface 50a of the valve rod 50 or the inner peripheral surface 41a of the bush 41. Note that, for example, any of nitriding treatment, chromizing treatment, stellite welding, chromium carbide thermal spraying, and the like is performed on a peripheral surface of a side on which the coating layer 51 is not formed, to which oxidation resistance is imparted. The outer peripheral surface 51a of the coating layer 51 and the inner peripheral surface 41a of the bush 41 have a predetermined gap for the valve rod 50 to slide in therebetween.

The valve rod 50 is driven in an up-down direction by the hydraulic drive mechanism 80, and thereby the valve element 60 abuts on or separates open from the valve seat 70. Thus, a flow rate of main steam flowing in from a steam inlet portion 31 and flowing out from a steam outlet portion 32 is regulated. Note that the number of rotations of the high-pressure turbine 11 is controlled by regulation of an amount of outflow steam from the steam outlet portion 32 with the steam control valve 21.

Next, the coating layer 51 will be described.

As illustrated in FIG. 3, on the outer peripheral surface 50a of the valve rod 50, the coating layer 51 is formed. The coating layer 51 is formed by PVD (Physical Vapor Deposition) coating. PVD coating treatment is the treatment in which a substance to form the coating layer 51 is subjected to high temperatures to be evaporated, and a solid coating film (coating layer 51) of the substance is formed on a surface of a base material.

Thus, in this embodiment, the coating layer 51 is formed by performing the PVD coating treatment on a surface of a base material constituting a predetermined structural part of the steam valve. That is, without performing diffusion-hardened surface treatment such as nitriding treatment, the PVD coating treatment is directly performed on the surface of the base material constituting the structural part to form the coating layer 51.

Here, the PVD coating treatment is preferably treated at 600° C. or less in consideration of an effect of heat on the base material subjected to the treatment. Note that the coating layer formed by performing the PVD coating treatment functions as a PVD coating layer.

The coating layer 51 is composed of a material having excellent slidability and having excellent oxidation resistance in a high-temperature environment. As a substance composing the coating layer 51, for example, there can be cited a Cr-based nitride such as CrN (chromium nitride), a Ti-based nitride such as TiAlN (titanium aluminum nitride), and the like. As the coating layer 51, in the Cr-based nitride and the Ti-based nitride, CrN and TiAlN are more suitable. Note than the substance composing the coating layer 51 is not limited to these, and may be composed of other substances having excellent slidability and excellent oxidation resistance in a high-temperature environment according to the purpose of use of the steam valve.

A film thickness of the coating layer 51 is preferably 2 m to 30 μm. By setting the film thickness of the coating layer 51 within this range, excellent oxidation resistance can be obtained. When the film thickness of the coating layer 51 is below 2 μm, a treatment time and costs are reduced, but a surface defect such as a pinhole may occur locally to cause a loss of oxidation resistance. When the film thickness of the coating layer 51 exceeds 30 μm, the oxidation resistance can be obtained, but the treatment time and the costs to form the coating layer 51 increase.

Here, in a member subjected to PVD coating, by performing a film removal in an electrolytic solution, that is, an electrolytic film removal, only the PVD coating can be easily removed without affecting the base material constituting the member. This allows, when the base material after removing the PVD coating is sound, the base material to be used by performing the PVD coating thereon again. That is, the coating layer 51 can be easily formed again.

Here, an oxidation rate on a surface of the coating layer 51 subjected to the PVD coating is 0.4×10⁻⁶ mm/h or less. In other words, oxide scale deposited per unit time on the surface of the coating layer 51 is 0.4×10⁻⁶ mm/h or less.

Note that the oxidation rate is a thickening amount of the oxide scale (a deposition amount of the oxide scale) deposited per unit time on the surface of the coating layer 51. A measuring method of the oxidation rate conforms to JIS Z2290 “Method for high-temperature corrosion test of metallic materials”.

In the above-described range of the oxidation rate, it is possible to have excellent oxidation resistance and reduce the deposition amount of the oxide scale per an operating time of the steam turbine. Thus, a cycle of disassembly and inspection of the steam valve can be made longer than a cycle of disassembly and inspection of a conventional steam valve.

A dynamic friction coefficient between the member on which the coating layer 51 is formed and the member sliding with the member on which the coating layer 51 is formed is not less than 0.25 nor more than 0.4. A measuring method of the dynamic friction coefficient conforms to JIS R1613 “Testing method for wear resistance of fine ceramics by ball-on-disc method”.

In the above-described range of the dynamic friction coefficient, it is possible to secure good slidability with the coating layer 51 without excessively hindering force in a sliding direction from the hydraulic drive mechanism 80.

A hardness of the coating layer 51 is 2000 HV (Vickers hardness) or more. Setting the hardness of the coating layer 51 within the above-described range can cause a hardness difference with respect to a hardness of the opposite-side member sliding with the coating layer 51. This allows the prevention of galling (stick). Further, by setting the hardness of the coating layer 51 within the above-described range, a strength of the member provided with the coating layer 51 can be increased.

According to the steam valve of the first embodiment, a simple configuration to provide the coating layer 51 on the sliding surface between the valve rod 50 and the bush 41 allows a reduction in the deposition amount, per the operating time of the steam turbine, of the oxide scale deposited on the outer peripheral surface 50a of the valve rod 50 and the inner peripheral surface 41a of the bush 41.

This increases an allowable total operating time until the gap in a sliding portion between the valve rod 50 and the bush 41 is closed. Thus, the cycle of disassembly and inspection of the steam valve of the first embodiment can be made longer than the cycle of disassembly and inspection of the conventional steam valve.

Further, according to the steam valve of the first embodiment, without extending the gap between the valve rod and the bush to make the cycle of disassembly and inspection long, also with a gap between conventional valve rod and bush maintained, the cycle of disassembly and inspection can be made longer than the cycle of conventional disassembly and inspection. Thus, since the gap with respect to the bush is not extended, problems do not arise such as progress of abrasion and an increase in vibration of the sliding portion due to a swing in a radial direction of the valve rod, a hitting defect of the valve element and the valve seat due to a deviation from the center of the valve rod, and a decrease in thermal efficiency as the steam turbine plant due to steam leakage from the gap between the valve rod and the bush.

Further, the deposition amount, per the operating time of the steam turbine, of the oxide scale, that is, an oxidation rate can be reduced, and thus, for example, even though the gap between the valve rod 50 and the bush 41 is made smaller than the gap between the conventional valve rod and bush, the cycle of disassembly and inspection of the steam valve can be set to be longer than the cycle of disassembly and inspection of the conventional steam valve. Moreover, making the gap between the valve rod 50 and the bush 41 smaller than the gap between the conventional valve rod and bush allows a further reduction in leakage of steam. This allows an inhibition of formation of the oxide scale deposited with time in the gap between the valve rod 50 and the bush 41 by leakage steam being condensed.

### Second Embodiment

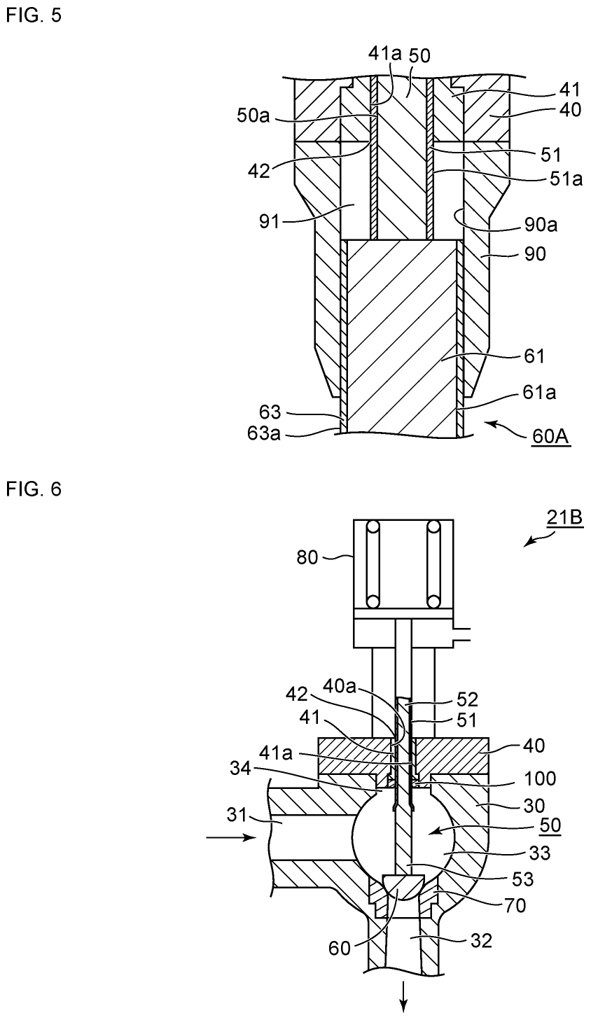

FIG. 4 is a view illustrating a vertical section of a steam valve of a second embodiment. FIG. 5 is a view enlarging and illustrating a cross section of a part of the steam valve of the second embodiment. Here, similarly to the first embodiment, a steam control valve 21A is exemplified to be described as a steam valve. Note that in the following embodiment, the same component parts as those of the configuration of the first embodiment are denoted by the same reference signs, and overlapping descriptions are omitted or simplified.

As illustrated in FIG. 4, the steam control valve 21A of the second embodiment includes a sleeve 90 at an end portion on a steam chamber 33 side of a valve cover 40. The sleeve 90 is constituted by a cylindrical member having a through hole 91 in a longitudinal direction at the center thereof. One end of the sleeve 90 is connected to the end portion on the steam chamber 33 side of the valve cover 40, and the other end side of the sleeve 90 extends to a steam outlet portion 32 side. A center axis of the sleeve 90 is located coaxially with a center axis of the bush 41. Further, these center axes are located coaxially with a center axis of the valve rod 50.

A valve element 60A provided at one end of the valve rod 50 includes a column-shaped portion 61 connected to the one end of the valve rod 50, and a hemispherical portion 62 abutting on a valve seat 70. The column-shaped portion 61 penetrates the through hole 91 of the sleeve 90. As illustrated in FIG. 5, on an outer peripheral surface 61a of the column-shaped portion 61, a coating layer 63 is formed. An outer peripheral surface 63a of the coating layer 63 and an inner peripheral surface 90a of the sleeve 90 constitute a sliding surface. On the outer peripheral surface 61a of the column-shaped portion 61, the coating layer 63 is formed on at least a portion of sliding with the inner peripheral surface 90a of the sleeve 90.

Here, an example in which the coating layer 63 is formed on the outer peripheral surface 61a of the column-shaped portion 61 is presented. The coating layer 63 may be formed on the inner peripheral surface 90a of the sleeve 90. That is, the coating layer 63 is formed on the outer peripheral surface 61a of the column-shaped portion 61 of the valve element 60A or the inner peripheral surface 90a of the sleeve 90. Note that, for example, any of nitriding treatment, chromizing treatment, stellite welding, chromium carbide thermal spraying, and the like is performed on a peripheral surface of a side on which the coating layer 63 is not formed, to which oxidation resistance is imparted. The outer peripheral surface 63a of the coating layer 63 and the inner peripheral surface 90a of the sleeve 90 have a predetermined gap for the column-shaped portion 61 to slide in therebetween.

In the steam control valve 21A, forming a steam balance chamber between the sleeve 90 and the valve element 60A allows a reduction in steam unbalance force due to a differential pressure of steam in front of and behind the valve element 60A.

The coating layer 63 is the same in configuration as the coating layer 51 in the first embodiment.

According to the steam valve of the second embodiment, a simple configuration to provide the coating layer 63 on the sliding surface between the column-shaped portion 61 of the valve element 60A and the sleeve 90 allows a reduction in a deposition amount, per an operating time of a steam turbine, of oxide scale deposited on the outer peripheral surface 61a of the column-shaped portion 61 and the inner peripheral surface 90a of the sleeve 90.

This increases an allowable total operating time until the gap in a sliding portion between the column-shaped portion 61 of the valve element 60A and the sleeve 90 is closed. Thus, a cycle of disassembly and inspection of the steam valve of the second embodiment can be made longer than a cycle of disassembly and inspection of a conventional steam valve.

Further, the deposition amount, per the operating time of the steam turbine, of the oxide scale, that is, an oxidation rate can be reduced, and thus, for example, even though the gap between the column-shaped portion 61 and the sleeve 90 is made smaller than a gap between conventional column-shaped portion and sleeve, the cycle of disassembly and inspection of the steam valve can be set to be longer than the cycle of disassembly and inspection of the conventional steam valve.

### Third Embodiment

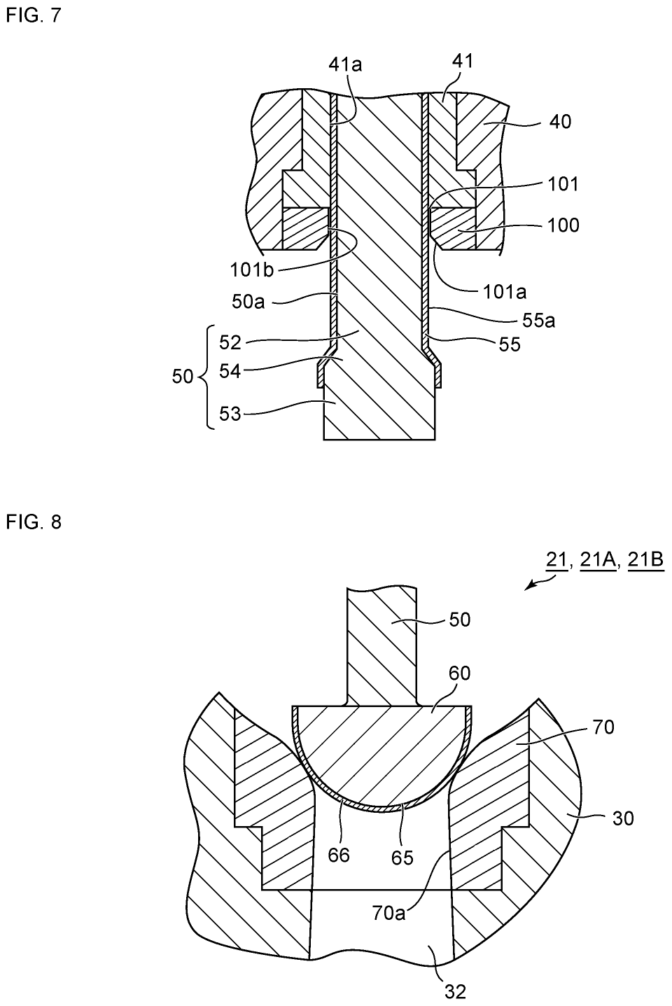

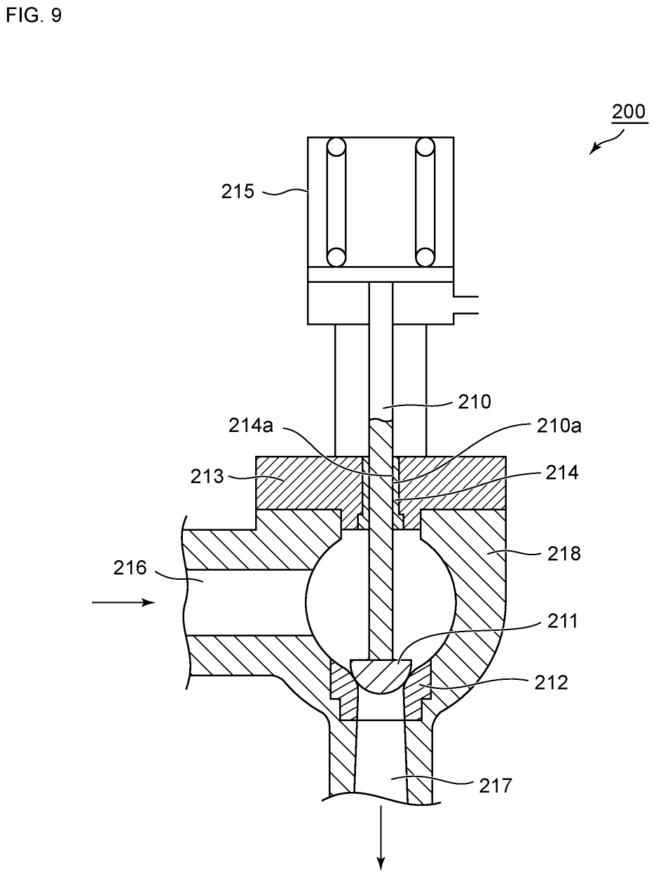

FIG. 6 is a view illustrating a vertical section of a steam valve of a third embodiment. FIG. 7 is a view enlarging and illustrating a cross section of a part of the steam valve of the third embodiment. Here, similarly to the first embodiment, a steam control valve 21B is exemplified to be described as a steam valve.

As illustrated in FIG. 6, the steam control valve 21B of the third embodiment includes a seat ring 100. The seat ring 100 is fitted in a through hole 40a of a valve cover 40 on a steam chamber 33 side further than a bush 41. The seat ring 100 is fitted in the through hole 40a to be in contact with the bush 41.

As illustrated in FIG. 7, the seat ring 100 is constituted by a circular member having a predetermined thickness. A valve rod 50 penetrates a hole portion 101 in a column shape at the center of the seat ring 100. A center axis of the seat ring 100 is located coaxially with a center axis of the bush 41. Further, these center axes are located coaxially with a center axis of the valve rod 50.

A peripheral edge on a steam chamber 33 side along a circumferential direction of the hole portion 101 in the seat ring 100 is provided with, for example, a chamfered portion 101a subjected to chamfering. The chamfered portion 101a is formed over the circumferential direction. The chamfered portion 101a is subjected to C chamfering, for example.

The valve rod 50 includes a small-diameter portion 52, and a large-diameter portion 53 larger in diameter than the small-diameter portion 52. In a boundary between the small-diameter portion 52 and the large-diameter portion 53, a stepped portion 54 is included. The small-diameter portion 52 is in a state of penetrating the bush 41 and the seat ring 100. The large-diameter portion 53 is located on a valve seat 70 side further than the seat ring 100. A diameter of the large-diameter portion 53 is set to be larger than a diameter of the hole portion 101. Further, at an end portion on the valve seat 70 side of the large-diameter portion 53, the valve element 60 is provided.

The stepped portion 54 is formed in a shape corresponding to a shape of the chamfered portion 101a of the seat ring 100. The stepped portion 54 is formed in a truncated conical shape having a side surface inclined to correspond to the shape of the chamfered portion 101a, for example. Note that the stepped portion 54 functions as an abutting portion.

On an outer peripheral surface 50a of the valve rod 50, a coating layer 55 is formed. The coating layer 55 is formed on at least the outer peripheral surface 50a sliding to an inner peripheral surface 41a of the bush 41 and an inner peripheral surface 101b of the hole portion 101 in the seat ring 100, and the outer peripheral surface 50a of the stepped portion 54 abutting on the chamfered portion 101a. Note that the coating layer 55 may be formed over the outer peripheral surface 50a of the large-diameter portion 53 of the valve rod 50, as illustrated in FIG. 7.

An outer peripheral surface 55a of the coating layer 55, and, the inner peripheral surface 41a of the bush 41 and the inner peripheral surface 101b of the hole portion 101 constitute a sliding surface. The outer peripheral surface 55a of the coating layer 55, and, the inner peripheral surface 41a of the bush 41 and the inner peripheral surface 101b of the hole portion 101 have a predetermined gap for the small-diameter portion 52 of the valve rod 50 to slide in therebetween.

Here, an example in which the coating layer 55 is formed on the outer peripheral surface 50a of the valve rod 50 is presented. The coating layer 55 may be formed on the inner peripheral surface 41a of the bush 41, the inner peripheral surface 101b of the hole portion 101, and the chamfered portion 101a in place of being formed on the outer peripheral surface 50a of the valve rod 50. Note that, for example, any of nitriding treatment, chromizing treatment, stellite welding, chromium carbide thermal spraying, and the like is performed on a peripheral surface of a side on which the coating layer 55 is not formed, to which oxidation resistance is imparted.

Here, when the valve element 60 is fully open, the stepped portion 54 of the valve rod 50 abuts on the chamfered portion 101a of the seat ring 100. For example, the steam control valve 21B is operated with the valve element 60 fully open at the time of normal operation of a steam turbine plant. In the steam control valve 21B, the abutment of the stepped portion 54 and the chamfered portion 101a functions as a stopper of determining a fully open position of the valve element 60.

Further, steam leaking to the gap between the inner peripheral surface 41a of the bush 41 and the inner peripheral surface 101b of the hole portion 101, and, the small-diameter portion 52 of the valve rod 50 is shut off, which allows improvement in efficiency of the steam turbine plant.

Note that the above-described abutment structure of the seat ring 100 and the valve rod 50 is an example, and is not limited to the above-described structure. This abutment structure only needs to have a configuration in which a part of the valve rod 50 abuts on a part of the seat ring 100 to close the gap between the valve rod 50 and the hole portion 101 from the steam chamber 33 side when the valve element 60 is in the fully open position. Further, the coating layer only needs to be formed on the abutting portion.

The coating layer 55 is the same in configuration as the coating layer 51 in the first embodiment.

According to the steam valve of the third embodiment, a simple configuration to provide the coating layer 55 on the sliding surface between the small-diameter portion 52 of the valve rod 50, and, the inner peripheral surface 41a of the bush 41 and the inner peripheral surface 101b of the hole portion 101 allows a reduction in a deposition amount, per an operating time of a steam turbine, of oxide scale deposited on the inner peripheral surface 41a of the bush 41 and the inner peripheral surface 101b of the hole portion 101.

Providing the coating layer 55 on an abutting surface of the stepped portion 54 of the valve rod 50 and the chamfered portion 101a of the seat ring 100 allows a reduction in a deposition amount, per the operating time of the steam turbine, of oxide scale deposited on the stepped portion 54 of the valve rod 50 and the chamfered portion 101a of the seat ring 100.

Further, a reduction in the deposition amount of the oxide scale on the abutting surface of the stepped portion 54 and the chamfered portion 101a allows a decrease in an amount of leakage steam to the gap between the inner peripheral surface 41a of the bush 41 and the inner peripheral surface 101b of the hole portion 101, and, the small-diameter portion 52 of the valve rod 50.

This increases an allowable total operating time until the gap in a sliding portion between the small-diameter portion 52 of the valve rod 50, and, the inner peripheral surface 41a and the bush 41 and the inner peripheral surface 101b of the hole portion 101 is closed. Thus, a cycle of disassembly and inspection of the steam valve of the third embodiment can be made longer than a cycle of disassembly and inspection of a conventional steam valve.

### Fourth Embodiment

FIG. 8 is a view enlarging and illustrating a cross section of a part of a steam valve of a fourth embodiment. Here, in the previously-described steam valves of the first embodiment-the third embodiment, a configuration to provide a coating layer on an abutting portion of a valve element 60 and a valve seat 70 is illustrated. Thus, the configuration of the valve element 60 and the valve seat 70 will be mainly described.

As illustrated in FIG. 8, on an outer peripheral surface 65 in a hemispherical shape of the valve element 60 abutting on the valve seat 70, a coating layer 66 is formed. The coating layer 66 is formed on at least a portion abutting on the valve seat 70 on the outer peripheral surface 65. Note that FIG. 8 illustrates an example in which the coating layer 66 is formed all over the outer peripheral surface 65 of the valve element 60.

Here, an example in which the coating layer 66 is formed on the outer peripheral surface 65 of the valve element 60 is presented. The coating layer 66 may be formed on an outer peripheral surface 70a, abutting on the valve element 60, of the valve seat 70. In this case, the coating layer 66 is formed on at least a portion abutting on the valve element 60 on the outer peripheral surface 70a. Note that the coating layer 66 may be formed all over the outer peripheral surface 70a of the valve seat 70. Note that, for example, any of nitriding treatment, chromizing treatment, stellite welding, chromium carbide thermal spraying, and the like is performed on a peripheral surface of a side on which the coating layer 66 is not formed, to which oxidation resistance is imparted.

The coating layer 66 is the same in configuration as the coating layer 51 in the first embodiment.

Here, the valve element 60 shuts off steam flowing into the steam turbine by abutting on the valve seat 70. Thus, when a defect in hitting of an abutting surface of the valve element 60 and the valve seat 70 occurs, the steam passes through the abutting surface to flow into the steam turbine. When abnormality occurs in operation of the steam turbine, the steam flowing into the steam turbine is shut off and the steam turbine is stopped by fully closing the steam valve promptly. Therefore, it is important that the hitting on the abutting surface of the valve element 60 and the valve seat 70 is maintained and managed to be always in a good state.

Thus, in the steam valve of the fourth embodiment, a simple configuration to provide the coating layer 66 on the abutting portion of the valve element 60 and the valve seat 70 allows, at the abutting portion, a reduction in a deposition amount, per an operating time of a steam turbine, of oxide scale deposited on the outer peripheral surface 65 of the valve element 60 and the outer peripheral surface 70a of the valve seat 70.

This reduces a hitting defect on the abutting surface of the valve element 60 and the valve seat 70, and allows the steam turbine to be properly stopped also in an emergency. Further, a cycle of disassembly and inspection of the steam valve of the fourth embodiment can be made longer than a cycle of disassembly and inspection of a conventional steam valve. (Evaluation of oxide scale deposition amount and oxidation rate)

Next, to demonstrate that a deposition amount of oxide scale can be reduced in the steam valve of this embodiment, an oxide scale deposition amount and an oxidation rate were evaluated.

In this evaluation, three kinds of sample members (a sample member 1-a sample member 3) were prepared. The same alloy for high temperatures was used for a base material of any of the sample members, and was set to have the same shape and size.

Regarding the sample member 1, a coating layer was formed by performing PVD coating on a surface of the cleaned base material. The coating layer was formed by adsorbing a vaporized substance on the surface of the base material loaded in a vacuum chamber. Here, the coating layer was composed of TiAlN. A film thickness of the coating layer was set to 3 m. Note that the film thickness was adjusted depending on a time to adsorb the vaporized substance on the surface of the base material.

Regarding the sample member 2, on a surface of the cleaned base material, nitriding treatment was performed by a diffusion hardening method. A nitriding treatment layer was formed from a surface of the base material to a depth of approximately 50 μm.

The sample member 3 is the base material itself, and is provided with no coating layer or no surface treatment layer.

Note that the sample member 1 corresponds to this embodiment, and the sample member 2-the sample member 3 are comparative examples of falling outside a range of this embodiment.

The above-described sample members were each exposed in a water vapor atmosphere of 630° C. for 9000 hours. Then, a thickening amount (an oxide scale deposition amount) of each sample member was measured. The thickening amount was measured using a micrometer.

A measurement result of the thickening amount was presented by a thickening amount ratio (oxide scale deposition amount ratio) with the thickening amount of the sample member 2 set as “1”. The thickening amount ratio larger than 1 means a thickening amount larger than that of the sample member 2, and the thickening amount ratio smaller than 1 means a thickening amount smaller than that of the sample member 2.

The oxidation rate (mm/h) was calculated by dividing the thickening amount of each sample member by 9000 hours of an exposure time.

Table 1 presents the result of the oxide scale deposition amounts and the oxidation rates.

TABLE 1

| | Thickening amount ratio | Oxidation rate, mm/h |
|---|---|---|
| Sample member 1 | 0.055 | 0.33 × 10⁻⁶ |
| Sample member 2 | 1 | 6.0 × 10⁻⁶ |
| Sample member 3 | 2.416 | 14.5 × 10⁻⁶ |

As presented in Table 1, the thickening amount ratio in the sample member 1 is found obviously smaller than the thickening amount ratios in the sample member 2 and the sample member 3. Further, the oxidation rate in the sample member 1 is found obviously slower than the oxidation rates in the sample member 2 and the sample member 3.

Thus, the sample member 1 provided with the coating layer formed by PVD coating is found to have excellent oxidation resistance, and to be small in the deposition amount of the oxide scale and the deposition amount of the oxide scale per unit time.

Further, the oxidation rate in the sample member 1 according to this embodiment has a value one order of magnitude smaller also as compared with that of the sample member 2 subjected to the nitriding treatment adopted for a conventional steam valve, for example. From this result, in the steam valve of this embodiment, for example, even though the gap between the valve rod and the bush is made smaller than a gap between conventional valve rod and bush, the possibility is found that a cycle of disassembly and inspection of the steam valve can be set to be longer than a cycle of disassembly and inspection of the conventional steam valve. Moreover, in the steam valve of this embodiment, by making the gap between the valve rod and the bush smaller than the gap between the conventional valve rod and bush, it is found that leakage of steam can be further reduced.

According to the embodiments described above, the simple configurations allow a reduction in the deposition amount of oxide scale, per the operating time of the steam turbine, formed in the sliding portion or the like in the steam valve.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A steam valve comprising:
a valve casing including a steam inlet portion, a steam outlet portion, and a steam chamber, and having an opening portion communicating with the steam chamber;
a valve seat provided in a vicinity of the steam outlet portion in the steam chamber in the valve casing;
a valve cover installed on the valve casing to close the opening portion, and having a through hole;
a bush in a cylindrical shape, fitted in the through hole;
a valve rod penetrating the bush to be slidable therein; and
a valve element provided at one end of the valve rod, and provided to be capable of abutting on the valve seat, wherein
a PVD coating layer is formed on an outer peripheral surface of the valve rod sliding in the bush, or an inner peripheral surface of the bush.

2. The steam valve according to claim 1, comprising
a sleeve in a cylindrical shape provided on the steam chamber side of the valve cover, the sleeve having a center axis coaxial with a center axis of the bush, wherein:
the valve element comprises:
a column-shaped portion which is connected to one end of the valve rod, and slides to an inner peripheral surface of the sleeve; and
a hemispherical portion provided to be capable of abutting on the valve seat; and
a PVD coating layer is formed on an outer peripheral surface of the column-shaped portion sliding in the sleeve, or the inner peripheral surface of the sleeve.

3. The steam valve according to claim 1, comprising
a seat ring fitted on the steam chamber side further than the bush in the through hole of the valve cover, the seat ring being constituted by a circular member having a hole portion at a center, wherein:
the valve rod comprises an abutting portion which abuts on the seat ring to close a gap between the valve rod and the hole portion from the steam chamber side when the valve element is in a fully open position; and
a PVD coating layer is formed on an abutting surface on the seat ring of the abutting portion, or an abutting surface on the abutting portion of the seat ring.

4. The steam valve according to claim 1, wherein
a PVD coating layer is formed on an abutting surface on the valve seat of the valve element, or an abutting surface on the valve element of the valve seat.

5. A steam turbine plant comprising:
a steam generator;
a steam turbine;
a steam pipe which guides steam generated in the steam generator to the steam turbine; and
the steam valve according to claim 1 interposed in the steam pipe.

6. A steam turbine plant comprising:
a steam generator;
a steam turbine;
a steam pipe which guides steam generated in the steam generator to the steam turbine; and
the steam valve according to claim 2 interposed in the steam pipe.

7. A steam turbine plant comprising:
a steam generator;
a steam turbine;
a steam pipe which guides steam generated in the steam generator to the steam turbine; and
the steam valve according to claim 3 interposed in the steam pipe.

8. A steam turbine plant comprising:
a steam generator;
a steam turbine;
a steam pipe which guides steam generated in the steam generator to the steam turbine; and
the steam valve according to claim 4 interposed in the steam pipe.
